(19) United States
(12) Patent Application Publication
(10) Pub. No.: US 2016/0334580 A1
(43) Pub. Date: Nov. 17, 2016

(54) OPTICAL WAVEGUIDE INTERCONNECT

(71) Applicant: Corning Incorporated, Corning, NY (US)

(72) Inventors: Peng Chen, Painted Post, NY (US); Sheng Huang, Pittsburgh, PA (US); Ming-Jun Li, Horseheads, NY (US)

(21) Appl. No.: 15/153,111

(22) Filed: May 12, 2016

Related U.S. Application Data
(60) Provisional application No. 62/160,816, filed on May 13, 2015.

(51) Int. Cl. G02B 6/26

(52) U.S. Cl. CPC G02B 6/26

(57) ABSTRACT

A method for manufacturing an optical waveguide interconnect may comprise providing a substrate, irradiating portions of the substrate's interior volume by directing a processing laser beam into the substrate surface, thus defining one or more surfaces that function as optic components, forming an embedded waveguide in the interior volume by directing the processing laser beam into the substrate surface, and etching away the weakened portions of the substrate's interior volume overlying the defined surfaces using an etchant. The optic components and the waveguide may be aligned to be in optical communication with each other such that an input beam of light may strike the defined surface of a first optic component, traverse the waveguide, and strike the defined surface of a second optic component.

This application claims the benefit of priority under 35 U.S.C. §119 of U.S. Provisional Application Ser. No. 62/160816 filed on May 13, 2015, the content of which is relied upon and incorporated herein by reference in its entirety.

### FIELD

The present disclosure generally relates to optic components, optical waveguide interconnects, and methods for manufacturing the same.

### BACKGROUND

Optical waveguide interconnects may be used to address issues with bandwidth bottlenecks potentially limited by the use of electrical wire at circuit board levels. Polymeric waveguides are often employed, but can be limited in high bandwidth applications by poor thermal stability characteristics. The present disclosure relates to an integrated laser manufacturing solution to manufacture board-level optical waveguide interconnects, such as those made in a glass substrate.

### SUMMARY

Optionally, a method for manufacturing an optic component may comprise providing a substrate having a surface and an interior volume of solid material; and irradiating a portion of the interior volume by directing a processing laser beam into the substrate surface. The irradiating may be carried out under conditions effective to expose and weaken the solid material within the irradiated portion, which may define a surface, optionally further including solid material adjacent to the surface that functions as an optic component.

Optionally, a method for manufacturing an optical waveguide interconnect may comprise providing a substrate having a surface and an interior volume of solid material; and, irradiating at least two portions of the interior volume by directing a processing laser beam into the substrate surface. The irradiating may be carried out under conditions effective to expose and weaken the solid material overlying the at least two portions, which may define first and second surfaces, optionally further including solid material adjacent to one or more of the surfaces, that function as first and second optic components. The method for manufacturing may further comprise forming an embedded waveguide in the interior volume by directing the processing laser beam into the substrate surface and etching away the weakened portions of the interior volume overlying the first and second defined surfaces using an etchant. The first and second optic components and the waveguide may be aligned to be in optical communication with each other such that an input beam of light may strike the defined surface of the first optic component, traverse the waveguide, and strike the defined surface of the second optic component.

Optionally, an optical interconnect may comprise an opto-electronic device configured to transmit or receive light; and a substrate having a surface and containing an embedded input optic component having a first exposed surface, an embedded waveguide, and an embedded output optic component having a second exposed surface. The optic components and the embedded waveguide may be aligned to be in optical communication with each other.

Additional features and advantages of the present disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF SEVERAL VIEWS OF THE DRAWINGS

The following is a description of the figures in the accompanying drawings. The figures are not necessarily to scale, and certain features and certain views of the figures may be shown exaggerated in scale or in schematic in the interest of clarity or conciseness.

FIG. 1a shows an example of an optical component prior to removal of an irradiated portion.

FIG. 1b shows a cross-sectional view of an example of an optical component prior to removal of an irradiated portion.

FIG. 2a shows an example of an optical component prior to heat treatment.

FIG. 2b shows an enlarged view of the optical component surface encircled in FIG. 2a.

FIG. 3a shows an example of an optical component subsequent to heat treatment.

FIG. 3b shows an enlarged view of the optical component surface encircled in FIG. 3a.

FIG. 4a shows an example of a pair of optically-coupled optical components separated by a waveguide.

FIG. 4b shows an example of a pair of optically-coupled optical component separated by a waveguide and waveguide splitter.

FIG. 5 shows an example of a waveguide splitter or coupler.

FIG. 6 shows an example of an optical fiber mounted on a substrate.

FIG. 7a shows an example of a guided-mode image of light that has traversed an optical fiber prior to reflecting off an optical component.

FIG. 7b shows an example of a guided-mode image of light that has traversed an optical fiber subsequent to reflecting off an optical component such as the optical component illustrated in FIG. 1b.

FIG. 7c shows an example of a guided-mode image of light that has traversed an optical fiber subsequent to reflecting off an optical component such as the optical component illustrated in FIG. 2a.

The following reference characters are used in this specification:
10 Substrate
12 Substrate surface
14 Interior volume
15 Portion
20 Optic component
20a Optic component
20b Optic component
22 Defined surface
25 Waveguide
27 Waveguide splitter
30 Nanograting
40 Input beam
42 Output beam
50 Opto-electronic device
52 Optic fiber

The foregoing summary, as well as the following detailed description, will be better understood when read in conjunction with the figures. It should be understood that the claims are not limited to the arrangements and instrumentalities shown in the figures. Furthermore, the appearance shown in the figures is one of many ornamental appearances that can be employed to achieve the stated functions of the apparatus.

### DETAILED DESCRIPTION

In the following detailed description, numerous specific details are set forth in order to provide a thorough understanding of the present invention. However, it will be clear to one skilled in the art that the present invention can be practiced without some or all of these specific details. In other instances, well-known features or processes may not be described in detail so as not to unnecessarily obscure the invention. In addition, like or identical reference numerals may be used to identify common or similar elements.

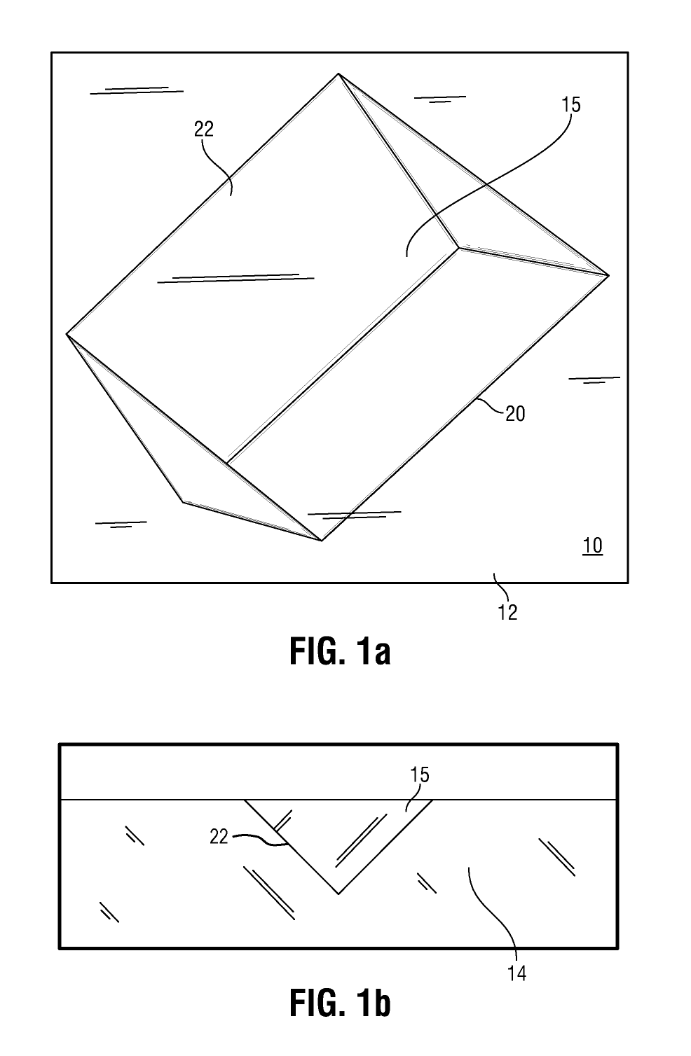

FIGS. 1a, 1b, 2a, 2b, 3a, and 3b illustrate an example of a substrate 10 of the present disclosure, in which an optic component 20 has been formed. The substrate 10 may be a silica glass. The substrate may have a substrate surface 12 and an interior volume 14. The optic component 20 may be formed via irradiation by focusing a processing laser beam to expose and weaken a portion 15 of the interior volume 14. By irradiating this portion 15, a surface 22 may be defined. The defined surface 22 may function as an optic component 20. The irradiating may be performed by stairstep scanning a processing laser beam across the substrate surface 12 while focusing the processing laser beam at varying depths within the interior volume 14 to weaken the irradiated portion 15 overlying the defined surface 22. The processing laser beam may be generated, for example, by a deep UV (<351 nm) or a short pulse (<20 ps) laser source. For example, an ultrafast Ti:sapphire laser source may be used as the processing laser beam. The processing laser beam may be spatially shaped, for example using a cylindrical telescope, and may be focused into the substrate 10, for example using an aberration-corrected objective lens. The weakened irradiated portion 15 may be removed by using an etchant, such as a hydrofluoric acid (HF) solution.

Advantages of using the combined irradiating and etching manufacturing processes include greater accuracy (allowing for the introduction of finer details) and less damage to surrounding areas of the substrate 10 (for example, only the irradiated area is altered and no ablation debris is generated). Another advantage of the methods of the present disclosure is that the optic component 20 may be embedded.

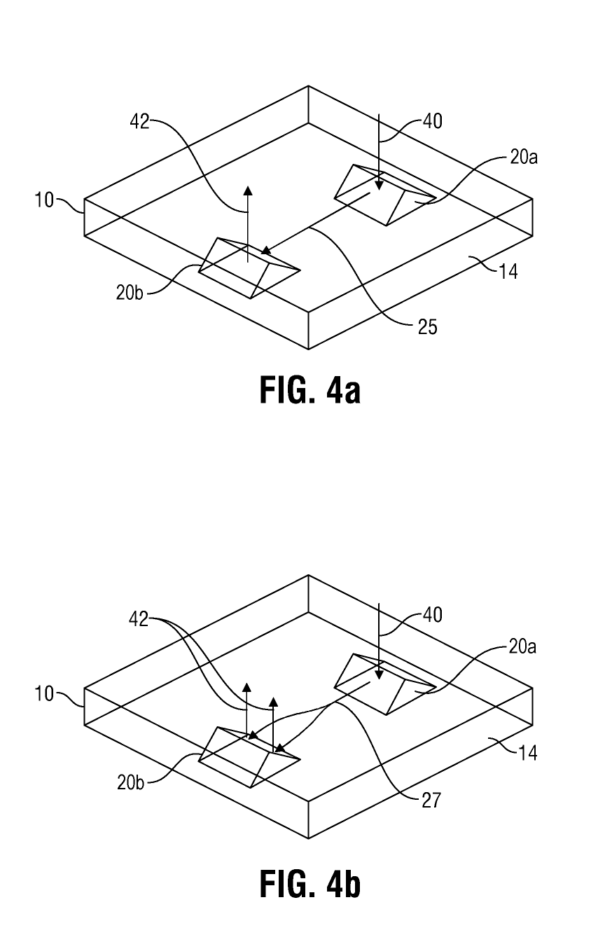

The processing laser beam may be used to write an embedded waveguide 25 (as shown schematically in FIGS. 4a and 4b) into the interior volume 14. The embedded waveguide 25 may remain intact during etching of the substrate 10.

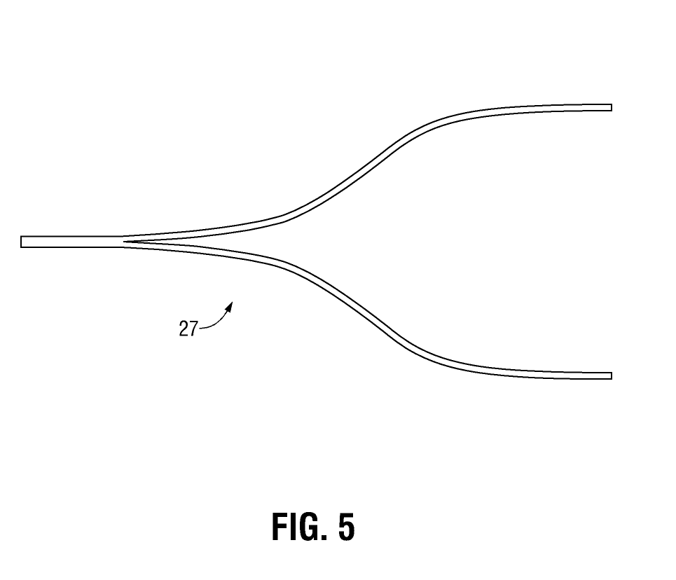

The optic component 20 may be any optic component that can be formed by the irradiation method described in the present disclosure. There are a number of known types of optic components that may be fabricated in this way, including optic components described by C. Debaes et al. in “Low-cost Micro-optical Modules for Board Level Optical Interconnections,” IEEE LEOS Newsletter Vol. 19, No. 3 (June 2005), available at http://photonicssociety.org/newsletters/jun05/hot_topic2. html; and described by S. V. Kartalopoulos in “Introduction to DWDM Technology: Data in a Rainbow—Chapter 4: Optical Spectral Filters and Gratings,” Wiley-IEEE Press (Dec. 1999), both of which are hereby incorporated by reference in their entireties. For example, the optic component 20 may be a mirror, a prism, a waveguide, a free space beam splitter, a waveguide, a waveguide splitter, a coupler, a waveguide coupler, a lens, a filter, a grating filter, a polarizer, a resonator, or a wavelength-division multiplexer (WDM). A mirror may be used to totally internally reflect beams of light. A mirror may be, for example, a 45 degree micro-mirror. A prism may be used as a free space beam splitter by partially internally reflecting a beam of light and partially refracting the beam of light. A waveguide, such as an embedded waveguide, may be used to direct a beam of light along a defined path. The waveguide may include a waveguide splitter, such as a 1×2 waveguide splitter, which may be Y-branched (as shown schematically in FIG. 5), or a waveguide coupler, such as a 2×1 waveguide coupler, which may also be Y-branched (as shown schematically in FIG. 5). A lens may be used to, for example, refocus a beam of light. A series of optic components 20, 20 may be used as a grating filter.

One of the advantages of the present disclosure is the ability to create a series of multiple optic components that may be optically connected by one or more embedded waveguides. The optic components may be connected without significant signal loss due to, e.g., scattering.

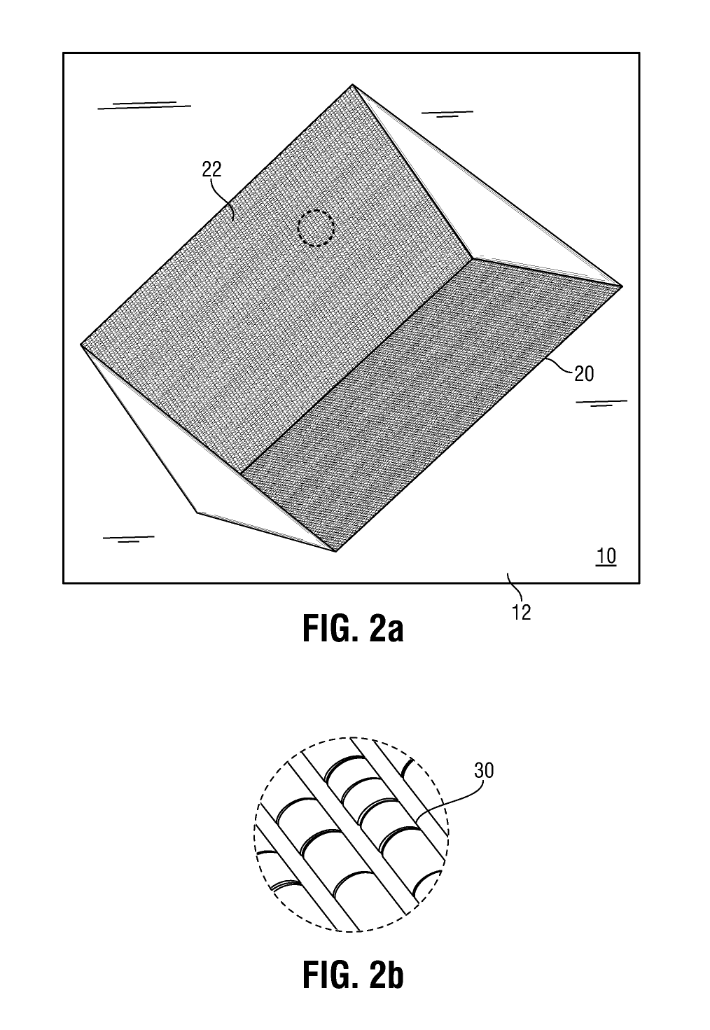

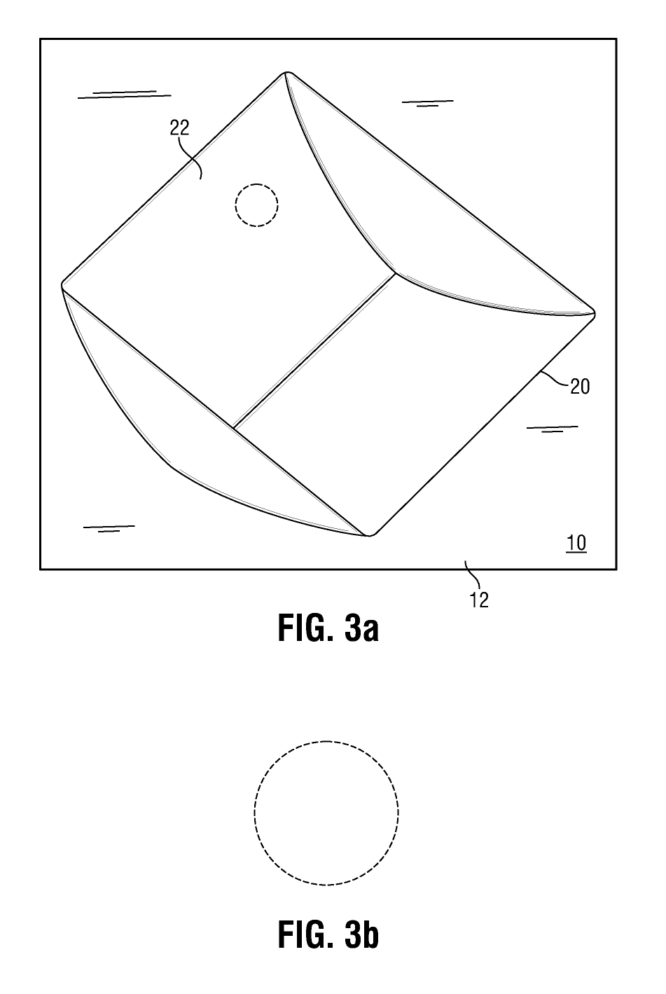

As shown in FIGS. 2a and 2b, the defined surface 22 of the optic component 20 may have surface roughness in the form of nanograting 30 (such as microscopic or sub-microscopic grooves or ridges) as a result of the irradiation process. The nanograting 30 may be formed during irradiating by the processing laser beam. For clarity, the nanograting 30 is not shown in FIGS. 1a and 1b, but it may be present prior to removal of the weakened irradiated portion 15. To reduce the surface roughness, the optic component 20 may be heated to cause the defined surface 20 to flow. To create localized heat at the optic component 20, a heat source such as a radiation source (e.g., a CO₂ laser) or a furnace may be used. As shown in FIGS. 3a and 3b, the surface roughness of the defined surface 22 may be reduced by the heat treatment. As shown in FIG. 3a, the heat treatment may introduce a slight curvature to the defined surface 22. The surface roughness may be reduced to below 100 nm over a 100×100 μm area or to such a level that the scattering loss of an input beam of light 40 reflecting off the defined surface 22 is kept below 1 dB and as low as 0.2 dB, alternatively as low as 0.3 dB, alternatively as low as 0.4 dB, alternatively as low as 0.5 dB, alternatively as low as 0.6 dB, alternatively as low as 0.7 dB, alternatively as low as 0.8 dB, alternatively as low as 0.9 dB.

The defined surface 22 may be generally planar or generally curved. The defined surface 22 may form a plane angle greater than zero with respect to the substrate surface 12. The plane angle may be between 0 and 90 degrees, for example between 10 and 80 degrees, or between 30 and 60 degrees, or between 40 and 50 degrees, or 45 degrees. As shown schematically in FIG. 4a, a plane angle of 45 degrees may be used to redirect an input beam of light 40 at an angle of 90 degrees. For example, this redirection may be a result of the input beam of light 40 being directly reflected by the defined surface 22 (or a coating on the surface 22) and/or internally reflected by the optic component 20. As depicted in FIGS. 1a, 1b, 2a, and 3a, for an input beam of light 40 to be internally reflected, the input beam of light would enter the substrate 10 from below before striking the defined surface 22 (i.e., for internal reflection, the defined surface 22 is opposite the side of light entry).

As shown schematically in FIGS. 4a and 4b, a pair of optic components 20a, 20b may be separated by an embedded waveguide 25 such that an input beam of light 40 may reflect off an input optic component 20a, traverse the embedded waveguide 25, and traverse the output optic component 20b as an output beam of light 42. As shown schematically in FIG. 4b, the embedded waveguide may comprise a waveguide splitter 27, such as a 1×2 Y-branched waveguide splitter, that splits the input beam of light 40 into two or more output beams of light 42, 42. FIG. 5 shows a schematic example of a Y-branched 1×2 waveguide splitter 27, assuming a single input beam of light 40 is entering the waveguide splitter 27 from the left as depicted and exiting as two output beams of light 42, 42 from the right as depicted; or a Y-branched 2×1 wavelength coupler, assuming two input beams of light 40, 40 are entering from the right as depicted and exiting as a single output beam of light 42 from the left as depicted.

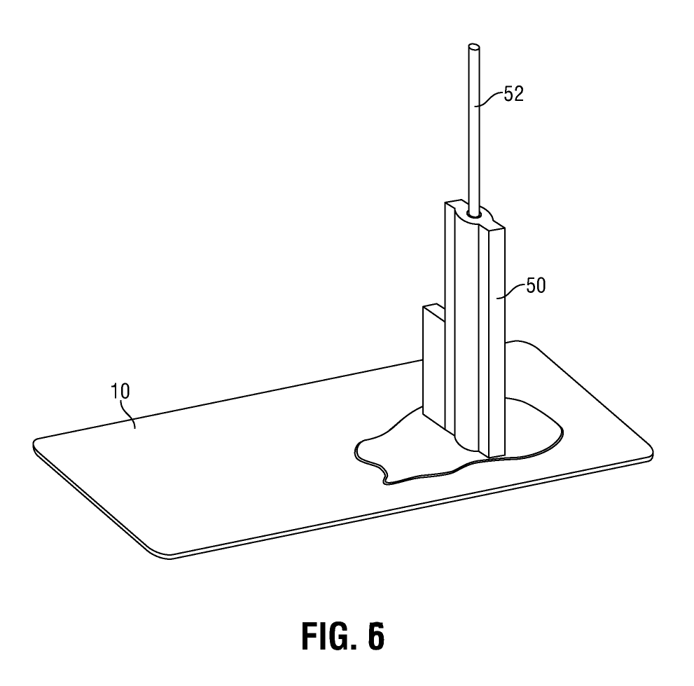

As shown schematically in FIG. 6, an opto-electronic device 50 may be mounted on a substrate 10. The opto-electronic device 50 may be configured to transmit or receive light. As depicted, the opto-electronic device 50 is vertically mounted, although this is optional. The opto-electronic device 50 may comprise an optic fiber 52.

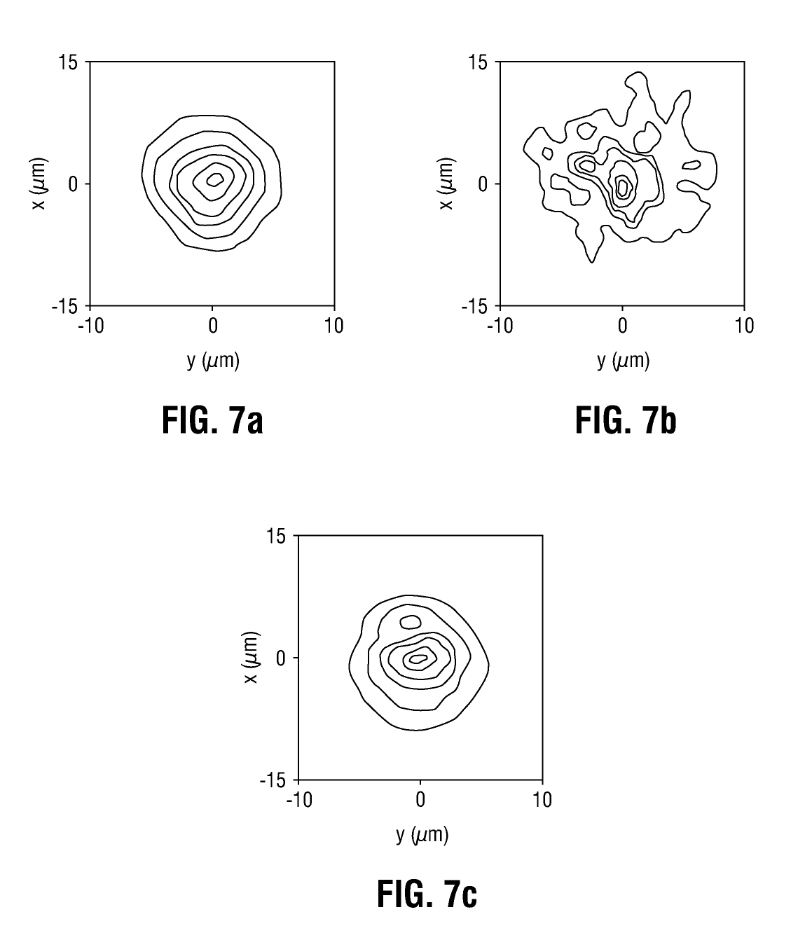

FIGS. 7a, 7b, and 7c represent guided-mode images of light from a waveguide. The x- and y-axes represent distances. In FIG. 7a, the guided-mode image comes from light that has not interacted with an optic component 20. In FIG. 7b, the guided-mode image comes from light that has been reflected off a defined surface 22 of an optic component 20 (here, a mirror), where the optic component 20 has a rougher surface texture, similar to the surface depicted in FIGS. 2a and 2b. In FIG. 7c, the guided-mode image comes from light that has been reflected off a defined surface 22 of an optic component 20 (here, a mirror), where the optic component 20 has a smoother surface texture, similar to the surface depicted in FIGS. 3a and 3b.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims.

1. A method for manufacturing an optic component, comprising:
a. providing a substrate having a surface and an interior volume of solid material; and
b. irradiating a portion of the interior volume by directing a processing laser beam into the substrate surface, the irradiating being carried out under conditions effective to expose and weaken the solid material within the irradiated portion, defining a surface that functions as an optic component.

2. The method of claim 1, in which the irradiating comprises stairstep scanning the processing laser beam across the substrate surface while focused at varying depths within the interior volume to weaken the irradiated portion of the interior volume overlying the defined surface.

3. The method of claim 1, further comprising etching away the weakened irradiated portion using an etchant.

4. The method of claim 3, wherein the etchant is a solution comprising hydrofluoric acid.

5. The method of claim 1, wherein the processing laser beam is generated by a deep UV or short pulse laser source.

6. The method of claim 1, in which the defined surface is generally planar.

7. The method of claim 1, in which the defined surface is generally curved.

8. The method of claim 1, in which the defined surface forms a plane angle greater than zero with respect to the substrate surface.

9. The method of claim 8, in which the plane angle is between 10 and 80 degrees, alternatively between 30 and 60 degrees, alternatively between 40 and 50 degrees, alternatively about 45 degrees.

10. The method of claim 1, wherein the optic component is chosen from the group consisting of: a mirror, a prism, a waveguide, a free space beam splitter, a waveguide, a waveguide splitter, a coupler, a waveguide coupler, a lens, a filter, a grating filter, a polarizer, a resonator, and a wavelength-division multiplexer (WDM).

11. The method of claim 10, wherein the optic component is a mirror.

12. The method of claim 10, wherein the optic component is a prism or a free space beam splitter.

13. A method for manufacturing at least two optically communicating optic components, comprising manufacturing at least two optic components by the method of claim 1, wherein the at least two optic components are aligned and optically coupled such that an input beam of light may strike the defined surface of a first optic component and subsequently strike the defined surface of a second optic component.

14. The method of claim 13, wherein the at least two optic components are aligned and optically coupled via a waveguide.

15. The method of claim 14, wherein the input beam of light may totally internally reflect off the first optic component onto the second optic component via the waveguide.

16. The method of claim 14, wherein the waveguide comprises a waveguide splitter or waveguide coupler.

17. The method of claim 1, further comprising heating the optic component to cause the defined surface of the optic component to flow, to decrease the surface roughness of the optic component.

18. The method of claim 17, wherein the heating is provided by a radiation heat source.

19. The method of claim 18, wherein the radiation heat source is a CO₂ laser.

20. The method of claim 17, wherein the heating is provided by a furnace.
